(19) United States
(12) Patent Application Publication
(10) Pub. No.: US 2014/0301226 A1
(43) Pub. Date: Oct. 9, 2014

(54) APPARATUS AND METHOD FOR NETWORK MONITORING AND PACKET INSPECTION

(71) Applicant: ELECTRONICS AND TELECOMMUNICATIONS RESEARCH INSTITUTE, Daejeon (KR)

(72) Inventors: Yun-Chul CHOI, Daejeon (KR); Myung-Ki SHIN, Seoul (KR); Hyoung-Jun KIM, Daejeon (KR)

(73) Assignee: ELECTRONICS AND TELECOMMUNICATIONS RESEARCH INSTITUTE, Daejeon (KR)

(21) Appl. No.: 14/245,391

(22) Filed: Apr. 4, 2014

(30) Foreign Application Priority Data
Apr. 9, 2013 (KR) 10-2013-0038770
Feb. 5, 2014 (KR) 10-2014-0013040

(51) Int. Cl. H04L 12/26

(52) U.S. Cl. CPC H04L 43/18
USPC 370/252

(57) ABSTRACT

An apparatus and a method for network monitoring and packet inspection capable of performing network monitoring and packet inspection in real time in a network system are disclosed. In accordance with an embodiment of the present invention, the apparatus for monitoring and packet inspection includes: a controller configured to transmit and receive an open flow protocol message and perform a network control; and a switch configured to include a flow table for data transfer and a security channel for connection with the controller, wherein the flow table includes target information which is information on a flow on which a user performs the monitoring and packet inspection.

### CROSS REFERENCE TO RELATED APPLICATION

This application claims the benefit of Korean Patent Application No. 10-2013-0038770, filed on Apr. 9, 2013 and 10-2014-0013040, filed on Feb. 5, 2014, which are hereby incorporated by reference in its entirety into this application.

### BACKGROUND OF THE INVENTION

1. Technical Field

The present invention relates to an apparatus and a method for network monitoring and packet inspection, and more particularly, to an apparatus and a method for network monitoring and packet inspection capable of performing network monitoring and packet inspection in real time in a network system.

2. Description of the Related Art

A network manager wishes to monitor a network state and thoroughly inspect suspected packets for security reasons.

To meet this demand, the existing system utilizes protocols such as NetFlow and sFlow to perform monitoring or combines packet inspection equipment with a suspected connection terminal having security fragility to perform monitoring. The existing method may be used to perform the monitoring even in the opened programmable network environment.

However, when using the existing method, the opened programmable network has a difficulty in providing a simple structure or services specialized for each flow.

In detail, when the opened programmable network environment uses the technologies used in the existing network environment as they are to monitor the real-time network environment and inspect specific packets, heterogeneous equipment linkage and software-based fast innovation which are advantages of the opened programmable network have disappeared.

Therefore, a need exists for a new method for real-time monitoring and packet inspection for the opened programmable network. As the related technology, there is U.S. Patent Application Publication No. 2011-0225282.

### SUMMARY OF THE INVENTION

Accordingly, the present invention has been made keeping in mind the above problems occurring in the conventional art, and an object of the present invention is to enable a user to monitor network environment or perform packet inspection on a specific flow while advantages of software defined network environment such as an open flow are maintained.

Another object of the present invention is to monitor an operation of an opened programmable network switch in real time and perform packet inspection on a user desired specific flow.

In accordance with an aspect of the present invention, there is provided an apparatus for monitoring and packet inspection, including: a controller configured to transmit and receive an open flow protocol message and perform a network; and a switch configured to include a flow table for data transfer and a security channel for connection with the controller, wherein the flow table includes target information which is information on a flow on which a user performs the monitoring and packet inspection.

The switch may transfer packets received from at least one node to destinations based on the flow table.

The controller may include a topology module configured to generate a state information message, node information, and packets to understand the overall system configuration which are transmitted and received to and from the switch and write the overall configuration diagram and a state diagram based on information collected on the basis of the generated packets.

The controller may include a database module configured to store entry information of the flow table which is transmitted and received to and from the switch.

The controller may include a routing module configured to allow the overall system to be operated as the switch or a router.

The controller may include a monitoring module configured to generate events which are associated with the state information message and a statistical information message received from the switch and collect information, to monitor the overall system in real time.

The controller may include a packet monitoring module configured to perform the packet monitoring on the specific flow or a specific port which is designated by the user.

The controller may include a user interface module which is a screen provided to a network manager or a user and the user interface module may include an information providing unit configured to provide information to the user; an input unit configured to receive the information from the user; and a monitoring unit configured to comprehensively monitor the overall system.

The switch may transfer the packets to the controller using the open flow protocol to select the destinations to which the packets received from at least one node are transferred.

The controller may determine actions to be performed on the packets received from the switch, transfer information on the determined actions to the switch or the router using the open flow protocol and perform the monitoring or the packet inspection on a specific flow based on the target information received from the switch.

In accordance with another aspect of the present invention, there is provided a method for monitoring and packet inspection, including: receiving, by a switch, packets from at least one node; determining, by a controller, actions to be performed on the packets received from the switch; transferring, by the controller, the information on the determined actions to the switch using the open flow protocol; and receiving, by the controller, the flow table held by the switch to perform the monitoring or the packet inspection on a specific flow included in the flow table based on target information which is the information on a flow on which a user performs the monitoring and packet inspection.

The method for monitoring and packet inspection may further include: after the transferring of the information on the determined actions to the switch, receiving, by a user interface module of the controller, information on a user desired specific flow or specific port.

The method for monitoring and packet inspection may further include: after the receiving of the information on the specific flow or the specific port, generating, by the controller, a request message requesting the information on the user desired specific flow or specific port and transferring the request message to the switch.

The request message may specify an interval or a period of a replay message or activate a flag bit and specify the interval of the replay message.

The method for monitoring and packet inspection may further include: after the transferring of the information on the determined actions to the switch, operating a thread to allow the switch to activate a monitoring flag for the specific flow or the specific port based on the request message or periodically generating the reply message.

The method for monitoring and packet inspection may further include: after the operating of the thread to periodically generate the replay message, transferring a message modifying the actions corresponding to the user desired specific flow or specific port to the switch when the packet inspection request for the specific flow or the specific port from the user is received.

The controller may include a topology module configured to generate a state information message, node information, and packets to understand the overall system configuration which is transmitted and received to and from the switch and write the overall configuration diagram and a state diagram based on information collected on the basis of the generated packets.

The controller may include a routing module configured to allow the overall system to be operated as the switch or a router.

The controller may include a monitoring module configured to generate events which are associated with the state information message and a statistical information message received from the switch and collect information, to monitor the overall system in real time.

The controller may include a packet monitoring module configured to perform the packet monitoring on the specific flow or a specific port which is designated by the user.

### BRIEF DESCRIPTION OF THE DRAWINGS

The above and other objects, features and advantages of the present invention will be more clearly understood from the following detailed description taken in conjunction with the accompanying drawings, in which:

FIG. 1 is a system configuration diagram of an apparatus for network monitoring and packet inspection in accordance with an embodiment of the present invention;

FIG. 2 is a diagram for describing a flow table of the apparatus for network monitoring and packet inspection in accordance with the embodiment of the present invention;

FIG. 3 is a diagram for describing an example of a controller of the apparatus for network monitoring and packet inspection in accordance with the embodiment of the present invention;

FIG. 4 is a flow chart of a method for network monitoring and packet inspection in accordance with an embodiment of the present invention; and

FIG. 5 is a diagram for describing an example of the method for network monitoring and packet inspection in accordance with the embodiment of the present invention.

### DESCRIPTION OF THE PREFERRED EMBODIMENTS

Embodiments of the present invention will be described in detail with reference to the accompanying drawings. The embodiments of the present invention are intended to fully describe the present invention to a person having ordinary knowledge in the art to which the present invention pertains. Accordingly, the shapes, sizes, etc. of components in the drawings may be exaggerated to make the description clearer. In the present specification, an overlapped description and a detailed description for well-known functions and configurations that may obscure the gist of the present invention will be omitted.

Preferred embodiments of the present invention are provided in order to more completely explain the present invention to those skilled in the art. Therefore, throughout the accompanying drawings, shapes, sizes, and the like, of components may be exaggerated for clarity.

In addition, in describing components of exemplary components of the present invention, terms such as first, second, A, B, (a), (b), etc. can be used. These terms are used only to differentiate the components from other components. Therefore, the nature, times, sequence, etc. of the corresponding components are not limited by these terms.

Hereinafter, an apparatus for network monitoring and packet inspection in accordance with an embodiment of the present invention will be described with reference to the accompanying drawings.

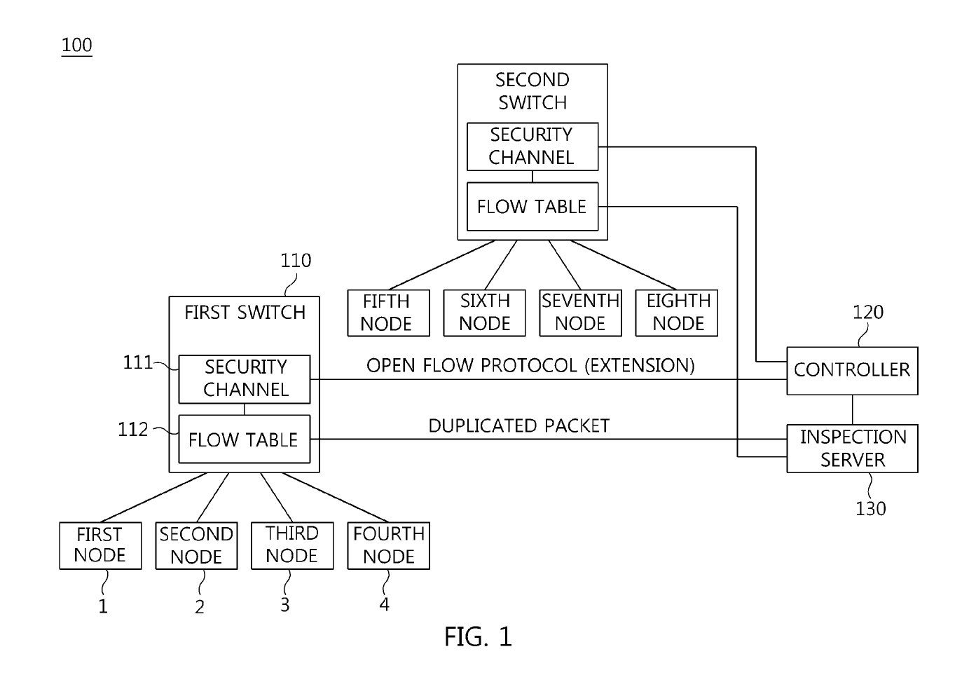

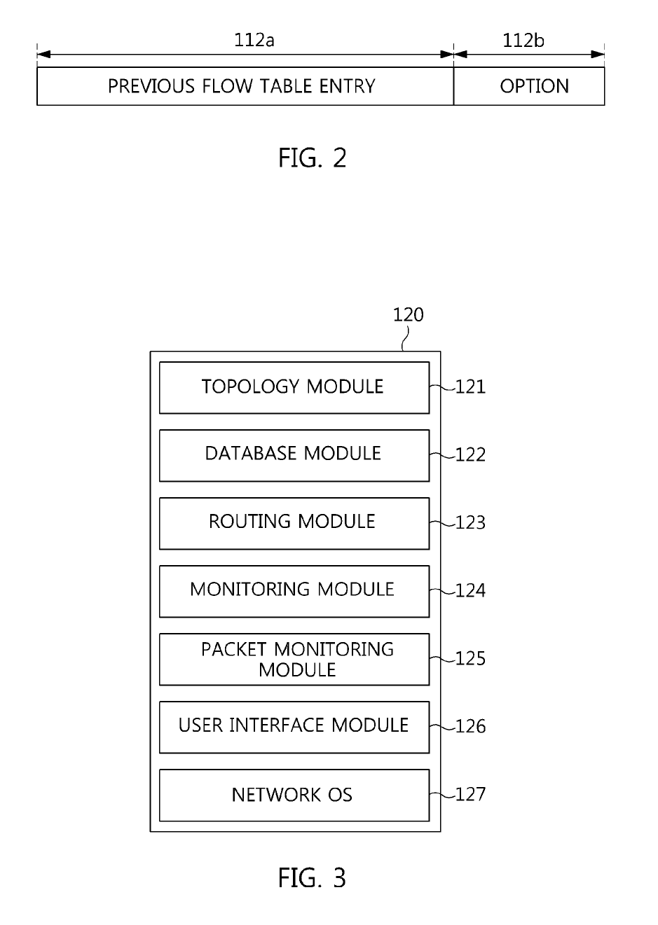

FIG. 1 is a system configuration diagram of an apparatus for network monitoring and packet inspection in accordance with an embodiment of the present invention. FIG. 2 is a diagram for describing a flow table of the apparatus for network monitoring and packet inspection in accordance with the embodiment of the present invention. FIG. 3 is a diagram for describing an example of a controller of the apparatus for network monitoring and packet inspection in accordance with the embodiment of the present invention.

An opened programmable network is divided into a switch unit (first switch) 110 configured to transfer data and a control unit (controller) 120 configured to perform a control, in which the switch unit is provided with a security channel 111 configured to connect a flow table 112 for data transfer with the control unit 120 and is connected to the control unit 120 via the security channel 111.

In this configuration, a standardized protocol is required for the connection and a technology used herein is an open flow technology. To support the real-time monitoring and the packet monitoring in the system, there is a need to extend a protocol as illustrated in FIG. 1.

First, a previous flow table 112a requires a portion 112b which is requested by a user for monitoring or packet inspection as illustrated in FIG. 2 and is displayed in the table. Further, as illustrated in FIG. 1, there is a need to extend a protocol which is suggested in advance. Further, as illustrated in FIG. 3, the controller 120 for supporting the monitoring and the packet inspection needs to be defined.

Describing in detail with reference to FIG. 1, an apparatus 100 for network monitoring and packet inspection in accordance with an embodiment of the present invention includes the controller 120 configured to transmit and receive an open flow protocol message and perform a network control and the switch 110 configured to include the flow table 112 for data transfer and a security channel 111 for connection with the controller, in which the flow table 112 includes target information which is information on a flow on which a user performs the monitoring and packet inspection.

In this case, the switch 110 may transfer packets received from at least one of nodes 1 to 4 to destinations based on the flow table 112.

Further, to select the destinations to which the packets received from at least one of the nodes 1 to 4 are transferred, the switch 110 may transfer the packets to the controller 120 using the open flow protocol.

In this case, the controller 120 determines actions to be performed on the packets received from the switch 110, transfers information on the determined actions to the switch 110 or a router using the open flow protocol, and performs the monitoring or the packet inspection on a specific flow based on the target information received from the switch 110.

Hereinafter, the controller of the apparatus 100 for network monitoring and packet inspection in accordance with the embodiment of the present invention will be described in detail.

Referring to FIG. 3, the controller 120 of the apparatus 100 for network monitoring and packet inspection in accordance with the embodiment of the present invention may include a topology module 121, a database module 122, a routing module 123, a monitoring module 124, a packet monitoring module 125, a user interface module 126, and a network OS 127.

In detail, the topology module 121 serves to generate a state information message, node information, and packets to understand the overall system configuration which are transmitted and received to and from the switch 110 and serves to write the overall configuration diagram and a state diagram based on information collected on the basis of the generated packets.

Further, the database module 122 serves to store entry information of the flow table 112 which is transmitted and received to and from the switch 110 and the routing module 123 serves to allow the overall system to be operated as the switch or the router.

Further, to monitor the overall system, the monitoring module 124 serves to generate events which are associated with the state information message and a statistical information message received from the switch 110 and collect information.

Further, the packet monitoring module 125 serves to perform the packet monitoring on the specific flow or a specific port which is designated by the user.

Further, the user interface module 126 is a screen which is provided to a network manager or a user and includes an information providing unit configured to provide information to the user, an input unit configured to receive the information from the user, and a monitoring unit configured to comprehensively monitor the overall system.

Hereinafter, a method for network monitoring and packet inspection in accordance with an embodiment of the present invention will be described with reference to the accompanying drawings. As described above, the repeated contents with the apparatus 100 for network monitoring and packet inspection in accordance with the embodiment of the present invention will be omitted.

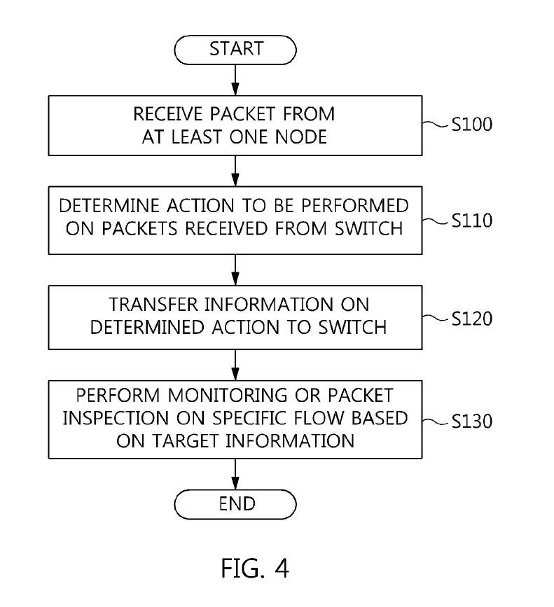

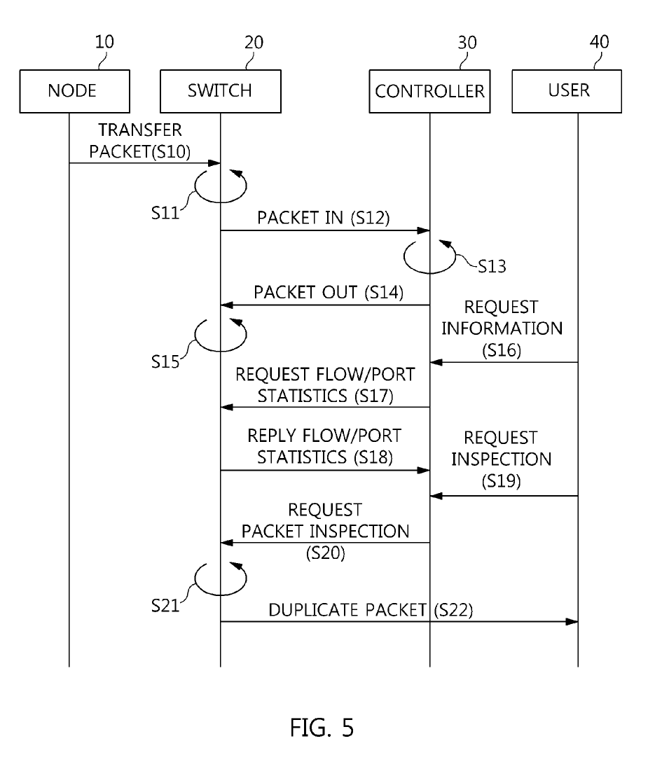

FIG. 4 is a flow chart of a method for network monitoring and packet inspection in accordance with an embodiment of the present invention. FIG. 5 is a diagram for describing an example of the method for network monitoring and packet inspection in accordance with the embodiment of the present invention.

Referring to FIG. 4, the method for network monitoring and packet inspection includes receiving, by the switch, the packets from at least one node (S100), determining, by the controller, the actions to be performed on the packets received from the switch (S110), transferring, by the controller, the information on the determined actions to the switch using the open flow protocol (S120), and receiving, by the controller, the flow table held by the switch to perform the monitoring or the packet inspection on the specific flow included in the flow table based on the target information which is the information on the flow on which the user performs the monitoring and packet inspection (S130).

In this case, after the transferring of the information on the determined actions to the switch (S120), the method for network monitoring and packet inspection may further include receiving, by the user interface module of the controller, the information on the user desired specific flow or specific port.

Further, after the receiving of the information on the specific flow or the specific port, the method for network monitoring and packet inspection may further include generating, by the controller, a request message requesting the information on the user desired specific flow or specific port and transferring the request message to the switch.

Herein, the request message may specify an interval or a period of a replay message or activate a flag bit and specify the interval of the replay message and after the transferring of the request message to the switch, the method for network monitoring and packet inspection may further include operating a thread to allow the switch to activate a monitoring flag for the specific flow or the specific port based on the request message or periodically generating the reply message.

Further, after the operating of the thread to periodically generate the replay message, the method for network monitoring and packet inspection may further include transferring a message modifying the actions corresponding to the user desired specific flow or specific port to the switch when the packet inspection request for the specific flow or the specific port from the user is received.

Referring to FIG. 5, the packets are transferred from at least one node 10 to the switch 20 (S10) and in this case, the switch 20 confirms its own flow table and transfers the packets based on the flow table when there are the packets matched with the flow table and transfers the packets to the controller 30 when there are no packets matched with the flow table (S12).

Next, the controller 30 determines what actions for the flow are performed (S13) and issues the determination to the switch 20 (S14).

Next, the switch 20 updates its own flow table by reflecting the determined actions (S15).

In this case, when the user requests the controller 30 to confirm the information on the specific flow or port (S16), the controller 30 generates the request message requesting the user desired specific flow or port information and transfers the generated request message to the switch (S17).

Next, the switch 20 receiving the request message operates the thread which activates the monitoring flag for the specific flow or port in response to the request message or periodically generates the reply message and periodically transfers the reply message for the monitoring request to the controller 30 (S18).

Further, when the controller 30 receives the packet inspection request for the specific flow or port from the user, the controller transfers the message modifying the action corresponding to the user desired specific flow or port to the switch 20 (S20). For example, in the case of previous action: port 1, the controller 30 transfers a message modifying action: port 1 to mod dest IP, mod dest mac, port 2. Next, the switch 20 updates the flow table to reflect the message received from the controller 30 to its own flow table (S21).

As described above, according to the apparatus 100 and the method for network monitoring and packet inspection in accordance with the embodiment of the present invention, the user may monitor the network environment or perform the packet inspection on the specific flow while the advantages of the software defined network environment such as the open flow are maintained.

Although the preferred embodiments of the present invention have been disclosed for illustrative purposes, those skilled in the art will appreciate that various modifications, additions and substitutions are possible, without departing from the scope and spirit of the invention as disclosed in the accompanying claims.

In accordance with the present invention, the user may monitor the network environment or perform the packet inspection on the specific flow while the advantages of the software defined network environment such as the open flow are maintained.

Furthermore, in accordance with the present invention, the opened programmable network switch operation may be monitored in real time and the packet inspection may be performed on the user desired specific flow.

Although the apparatus 100 and method for monitoring and packet inspection in accordance with the exemplary embodiments of the present invention are not limited to the configuration and method of the exemplary embodiments descried above, those skilled in the art will appreciate that various modifications, additions and substitutions are possible, without departing from the scope and spirit of the invention as disclosed in the accompanying claims.

What is claimed is:

1. An apparatus for monitoring and packet inspection, comprising:
a controller configured to transmit and receive an open flow protocol message and perform a network control; and
a switch configured to include a flow table for data transfer and a security channel for connection with the controller,
wherein the flow table comprises target information which is information on a flow on which a user performs the monitoring and packet inspection.

2. The apparatus of claim 1, wherein the switch transfers packets received from at least one node to destinations based on the flow table.

3. The apparatus of claim 1, wherein the controller comprises a topology module configured to generate a state information message, node information, and packets to understand the overall system configuration which are transmitted and received to and from the switch and write the overall configuration diagram and a state diagram based on information collected on the basis of the generated packets.

4. The apparatus of claim 1, wherein the controller comprises a database module configured to store entry information of the flow table which is transmitted and received to and from the switch.

5. The apparatus of claim 1, wherein the controller comprises a routing module configured to allow the overall system to be operated as the switch or a router.

6. The apparatus of claim 1, wherein the controller comprises a monitoring module configured to generate events which are associated with the state information message and a statistical information message received from the switch and collect information, to monitor the overall system in real time.

7. The apparatus of claim 1, wherein the controller comprises a packet monitoring module configured to perform the packet monitoring on the specific flow or a specific port which is designated by the user.

8. The apparatus of claim 1, wherein the controller comprises a user interface module which is a screen provided to a network manager or a user and the user interface module comprising:
an information providing unit configured to provide information to the user;
an input unit configured to receive the information from the user; and
a monitoring unit configured to comprehensively monitor the overall system.

9. The apparatus of claim 1, wherein the switch transfers the packets to the controller using the open flow protocol to select the destinations to which the packets received from at least one node are transferred.

10. The apparatus of claim 9, wherein the controller determines actions to be performed on the packets received from the switch, transfers information on the determined actions to the switch or the router using the open flow protocol and performs the monitoring or the packet inspection on a specific flow based on the target information received from the switch.

11. A method for monitoring and packet inspection, comprising:
receiving, by a switch, packets from at least one node;
determining, by a controller, actions to be performed on the packets received from the switch;
transferring, by the controller, the information on the determined actions to the switch using the open flow protocol; and
receiving, by the controller, the flow table held by the switch to perform the monitoring or the packet inspection on a specific flow included in the flow table based on target information which is the information on a flow on which a user performs the monitoring and packet inspection.

12. The method of claim 11, further comprising:
after the transferring of the information on the determined actions to the switch, receiving, by a user interface module of the controller, information on a user desired specific flow or specific port.

13. The method of claim 12, further comprising:
after the receiving of the information on the specific flow or the specific port, generating, by the controller, a request message requesting the information on the user desired specific flow or specific port and transferring the request message to the switch.

14. The method of claim 13, wherein the request message specifies an interval or a period of a replay message or activates a flag bit and specifies the interval of the replay message.

15. The method of claim 14, further comprising:
after the transferring of the information on the determined actions to the switch, operating a thread to allow the switch to activate a monitoring flag for the specific flow or the specific port based on the request message or periodically generating the reply message.

16. The method of claim 15, further comprising:
after the operating of the thread to periodically generate the replay message, transferring a message modifying the actions corresponding to the user desired specific flow or specific port to the switch when the packet inspection request for the specific flow or the specific port from the user is received.

17. The method of claim 11, wherein the controller comprises a topology module configured to generate a state information message, node information, and packets to understand the overall system configuration which transmit and receive to and from the switch and write the overall configuration diagram and a state diagram based on information collected on the basis of the generated packets.

18. The method of claim 11, wherein the controller comprises a routing module configured to allow the overall system to be operated as the switch or a router.

19. The method of claim 11, wherein the controller comprises a monitoring module configured to generate events which are associated with the state information message and a statistical information message received from the switch and collect information, to monitor the overall system in real time.

20. The method of claim 11, wherein the controller comprises a packet monitoring module configured to perform the packet monitoring on the specific flow or a specific port which is designated by the user.
